(19) United States
(12) Patent Application Publication
(10) Pub. No.: US 2024/0046927 A1
(43) Pub. Date: Feb. 8, 2024

(54) METHODS AND SYSTEMS FOR VOICE CONTROL

(71) Applicant: Comcast Cable Communications, LLC, Philadelphia, PA (US)

(72) Inventor: Scott Kurtz, Philadelphia, PA (US)

(21) Appl. No.: 18/159,316

(22) Filed: Jan. 25, 2023

Related U.S. Application Data
(60) Provisional application No. 63/394,472, filed on Aug. 2, 2022.

(51) Int. Cl. G10L 15/22; G10L 15/18; G10L 25/78; G10L 15/30

(52) U.S. Cl. CPC G10L 15/22; G10L 15/18; G10L 25/78; G10L 15/30; G10L 2015/088

(57) ABSTRACT

One or more portions of audio input may be detected. One or more directions associated with the one or more portions of audio input may be determined. A difference in direction between the one or more directions may be determined. An end of speech may be determined based on the difference in direction. An action may be taken based on the end of speech.

### RELATED APPLICATIONS

This application claims the priority benefit of U.S. Provisional Application No. 63/394,472, filed Aug. 2, 2022, the entirety of which is incorporated herein by reference.

### BACKGROUND

Speech recognition systems facilitate human interaction with computing devices, such as voice enabled smart devices, by relying on speech. Such systems employ techniques to identify words spoken by a human user based on a received audio input (e.g., detected speech input, an utterance) and, combined with speech recognition and natural language processing techniques determine one or more operational commands associated with the audio input. These systems enable speech-based control of a computing device to perform tasks based on the user's spoken commands. However, present systems may send too much trailing audio after the desired speech has ended. Excessive trailing audio may cause delays in processing a voice command by increasing network load and processing requirements, and reduces accuracy of command execution, all of which degrade user experience.

### SUMMARY

It is to be understood that both the following general description and the following detailed description are exemplary and explanatory only and are not restrictive. Methods and systems are described for determining when a user is no longer interacting with a voice enabled device. A voice enabled device may detect audio intended for the voice enabled device but may also detect audio not intended for the voice enabled device. The unintended audio may be ignored or excluded from further processing. For example, the unintended audio may be determined based on a change of direction of the audio, a phase change associated with audio, or the like.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system;

FIG. 2A shows an example system;

FIG. 2B shows an example system;

FIG. 3 shows an example system;

FIG. 4A shows an example diagram;

FIG. 4B shows an example diagram;

FIG. 5A shows an example diagram;

FIG. 5B shows an example diagram;

FIG. 6A shows an example diagram;

FIG. 6B shows an example diagram;

FIG. 7A shows an example diagram;

FIG. 7B shows an example diagram;

FIG. 8 shows an example system;

FIG. 9 shows an example system;

FIG. 10 shows an example method;

FIG. 11 shows an example method;

FIG. 12 shows an example method; and

FIG. 13 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special-purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio.

This detailed description may refer to a given entity performing some action. It should be understood that this language may in some cases mean that a system (e.g., a computer) owned and/or controlled by the given entity is actually performing the action.

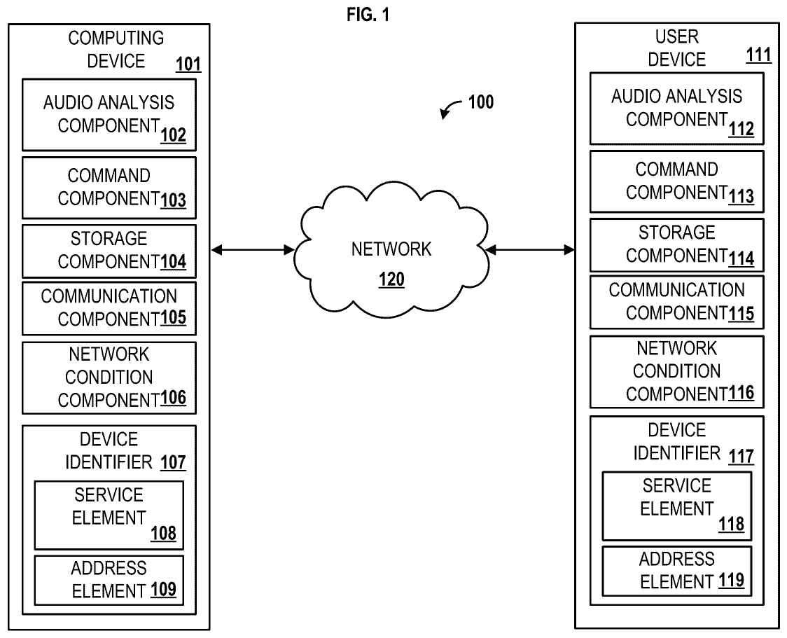

FIG. 1 shows an example system 100. The system 100 may comprise a computing device 101 (e.g., a computer, a server, a content source, etc.), a user device 111 (e.g., a voice assistant device, a voice enabled device, a smart device, a computing device, etc.), and a network 120. The network 120 may be a network such as the Internet, a wide area network, a local area network, a cellular network, a satellite network, and the like. Various forms of communications may occur via the network 120. The network 120 may comprise wired and wireless telecommunication channels, and wired and wireless communication techniques.

The user device 111 may comprise an audio analysis component 112, a command component 113, a storage component 114, a communications component 115, a device identifier 117, a service element 118, and an address element 119. The storage component may be configured to store audio profile data associated with one or more audio profiles associated with one or more audio sources (e.g., one or more users). For example, a first audio profile of the one or more audio profiles may be associated with a first user of the one or more users. Similarly, a second audio profile of the one or more audio profiles may be associated with a second user of the one or more users. The one or more audio profiles may comprise historical audio data such as voice signatures or other characteristics associated with the one or more users. For example, the one or more audio profiles may be determined (e.g., created, stored, recorded) during configuration or may be received (e.g., imported) from storage.

For example, the one or more audio profiles may store audio data associated with a user speaking a wake word. For example, the one or more audio profiles may comprise information like an average volume at which the user speaks the wake word, a duration or length of time the user takes to speak the wake word, a cadence at which the user speaks the wake word, a noise envelop associated with the user speaking the wake word, frequency analysis of the user speaking the wake word, combinations thereof, and the like.

The user device 111 may comprise one or more microphones. The audio analysis component 112 may comprise or otherwise be in communication with the one or more microphones. The one or more microphones may be configured to receive the one or more audio inputs. The audio analysis component 112 may be configured to detect the one or more audio inputs. The one or more audio inputs may comprise audio originating from (e.g., caused by) one or more audio sources. The one or more audio sources may comprise, for example, one or more people, one or more devices, one or more machines, combinations thereof, and the like. The audio analysis component 112 may be configured to convert the analog signal to a digital signal. For example, the audio analysis component 112 may comprise an analog to digital converter.

For example, the audio analysis component 112 may determine audio originating from a user speaking in proximity to the user device 111. The one or more audio inputs may be speech that originates from and/or may be caused by a user, a device (e.g., a television, a radio, a computing device, etc.), and/or the like.

The audio analysis component 112 may be configured to determine, based on the detected audio, one or more wake words and/or portions thereof and/or one or more utterances including, for example, one or more operational commands. The one or more operational commands may be associated with the one or more utterances. The audio analysis component 112 may be configured to determine, based on audio data (e.g., as a result of processing analog audio signals), spatial information associated with (e.g., location, distance, relative position of) the one or more audio sources. The audio analysis component may be configured to process one or more analog audio signals and determine, based on processing the one or more analog audio signals, spatial information associated with (e.g., a location, direction, distance, relative position, changes therein) the one or more audio sources. For example, the audio analysis component 112 may be configured to determine a volume (e.g., a received signal power), reverberation, dereverberation, difference in time of arrival at the microphones, phase difference between the various microphones, one or more component frequencies associated with the one or more analog audio signals, a frequency response (e.g, a power spectrum or power spectral density), combinations thereof, and the like. Processing the one or more analog audio signals may comprise sampling (and/or resampling) the one or more analog audio signals, filtering (e.g., low-pass, high-pass, band-pass, band-rejection/stop filtering, combinations thereof, and the like), equalization, gain control, beamforming, converting from analog to digital, compressing, decompressing, encrypting, decrypting, combinations thereof, and the like. For example, the filtering may be done using a Fast Fourier Transform (FFT) or subband decomposition of the signal - either of which converts the time domain signal into a frequency domain signal. Further, beamforming can help determine direction of arrival. Spatial information associated with the one or more audio sources may be determined. The spatial information may be determined based on the audio data. For example a distance between the user device and a first audio source of the one or more audio sources may be determined. Similarly, a distance to a second audio source of the one or more audio sources may be determined.

For example, a direction associated with the first portion of the audio input and a direction associated with a second portion of the audio input may be determined. The second portion of the audio input may originate from the first source or a second source. For example, the second portion of the audio input may originate from the first source, however the first source has moved (e.g., changed location, or position), or the first source has been reoriented. For example, a user may speak the first portion of the audio input towards the user device, but then move his head before speaking the second portion of the audio input such that the direction of travel of a sound wave associated with the second portion of the audio input is different from a direction of travel of a sound wave associated with the first portion of the audio input.

The second portion of the audio input may originate from an interfering speaker. For example, the first portion of the audio input may comprise speech (e.g., an utterance) originating from a target user while the second portion (e.g., an interrupting portion) may comprise speech originating from a second speaker (e.g., the interfering speaker or user).

For example, the audio analysis component 112 may be configured to determine a time difference of arrival (e.g., TDOA). For example, a first microphone of the one or more microphones may detect (e.g., receive, determine, encounter) the first portion of the audio input at a first time and a second microphone of the one or more microphones may detect the first portion of the audio input at a second time (e.g., after the first microphone). As such, it may be determined the source of the first portion of the audio input is closer to (e.g., in the direction of) the first microphone.

Based on determining the wake word, the user device 111 may process the audio input. For example, processing the audio input may include, but is not limited to, opening a communication session with another device (e.g., the computing device 101, a network device such as the network 120, combinations thereof, and the like). Processing the audio data may comprise determining the one or more utterances. The one or more utterances may comprise one or more operational voice commands. For example, “HBO,” “tune to HBO,” “preview HBO,” “select HBO,” and/or any other phonemes, phonetic sounds, and/or words that may be ambiguously associated with the stored operational command. Selecting between similar operational commands such as “tune to HBO,” “preview HBO,” “select HBO,” and/or the like may be based, for example, on when the audio content is detected and historical operational commands received by the user device 111. Processing the audio input may comprise causing an action such as sending a query (e.g., “what is the weather like today?”), sending a request for content, causing a tuner to change a channel, combinations thereof, and the like. For example, a target speaker (e.g., a user associated with the user device, a user in proximity to the use device) may speak a command while an interfering talker is also speaking. The interfering talker may continue to speak past the end of the target talker's command. Using direction of arrival information, the audio analysis module may reject or crop the interfering talker's portion of the audio input. The direction of arrival may be determined, by example by determining characteristics of a propagating analog audio signal such as angle of arrival (AoA), time difference of arrival (TDOA), frequency difference of arrival (FDOA), beamforming, other similar techniques, combinations thereof, and the like. For example, in angle of arrival, a two element array spaced apart by one-half the wavelength of an incoming wave may determine direction of arrival.

Measurement of AoA can be done by determining the direction of propagation of a wave incident on a microphone array. The AoA can be calculated by measuring the time difference of arrival (TDOA) between individual elements of the array. For example, if a wave is incident upon a linear array from a direction of arrival perpendicular to the array axis, it will arrive at each microphone. This will yield 0° phase-difference measured between the the microphone elements, equivalent to a 0° AoA. If a wave is incident upon the array along the axis of the array, then the phase characteristics will be measured between the elements, corresponding to a 90° AoA. Time difference of arrival (TDOA) is the difference between times of arrival (TOAs). Time of arrival (TOA or ToA) is the absolute time instant when a signal emanating from a source reaches a remote receiver. The time span elapsed since the time of transmission (TOT or ToT) is the time of flight (TOF or ToF).

The user device 111 may determine, (e.g., receive) a second portion of the one or more portions of the audio input. The audio analysis component 112 may determine a second direction associated with a second portion of the audio input may be determined. For example, the second portion of the audio input may comprise an utterance such as a command. For example, a time difference of arrival (e.g., TDOA) may be determined. For example, the second microphone of the one or more microphones may detect (e.g., receive, determine, encounter) the second portion of the audio input at third first time and the first microphone of the one or more microphones may detect the second portion of the audio input at a fourth time (e.g., after the second microphone). As such, it may be determined the source of the second portion of the audio input is in a different location than the source of the first portion of the audio input.

Similarly, the audio analysis component 112 may be configured to determine a phase difference between microphone inputs. The phase difference may be measured individually on separate frequency bands where separation is done using a Fourier Transform, Subband Analysis, or similar. The direction of arrival of the audio in each frequency band may be determined based on the phase difference, the center frequency of the band, and the geometry of the microphones. For example, the phase difference varies slower as a function of direction of arrival compared to the phase difference at higher frequencies. Similarly, the phase difference increases as the spacing between a pair of microphones increases.

The change in location may be a change in direction, distance, position, combinations thereof, and the like. The user device may determine the change in location satisfies one or more thresholds. The one or more thresholds may comprise, for example, a quantity of degrees (e.g., a change in direction), a quantity of units of length such as feet or meters or the like (e.g., a change in distance), or a change in position relative to the user device and/or the computing device. For example, it may be determined the source of the second audio input is 90 degrees from the source of the first portion of the audio input. Based on the change in position satisfying a threshold, an end of speech indication may be determined (e.g., generated, sent, received, etc.). The end of speech indication may be configured to cause a change in processing the audio such as a termination.

The user device 111 may be associated with a device identifier 117. The device identifier 117 may be any identifier, token, character, string, or the like, for differentiating one user device (e.g., the user device 111, etc.) from another user device. The device identifier 117 may identify user device 111 as belonging to a particular class of user devices. The device identifier 117 may include information relating to the user device 111 such as a manufacturer, a model or type of device, a service provider associated with the user device 111, a state of the user device 111, a locator, and/or a label or classifier. Other information may be represented by the device identifier 117.

The device identifier 117 may have a service element 118 and an address element 119. The service element 118 may have or provide an interne protocol address, a network address, a media access control (MAC) address, an Internet address, or the like. The address service 118 may be relied upon to establish a communication session between the user device 111, a computing device 101, or other devices and/or networks. The address element 119 may be used as an identifier or locator of the user device 101. The address element 119 may be persistent for a particular network (e.g., network 120, etc.).

The service element 118 may identify a service provider associated with the user device 111 and/or with the class of the user device 111. The class of the user device 111 may be related to a type of device, a capability of a device, a type of service being provided, and/or a level of service (e.g., business class, service tier, service package, etc.). The service element 118 may have information relating to and/or provided by a communication service provider (e.g., Internet service provider) that is providing or enabling data flow such as communication services to the user device 111. The service element 118 may have information relating to a preferred service provider for one or more particular services relating to the user device 111. The address element 119 may be used to identify or retrieve data from the service element 118, or vice versa. One or more of the address element 119 and the service element 118 may be stored remotely from the user device 111 and retrieved by one or more devices such as the user device 111, the computing device 101, or any other device. Other information may be represented by the service element 118.

The network condition component 116 may be configured to one or more thresholds related to determining the end of speech (e.g., change in direction, change in volume) based on network conditions. For example, the network condition component 116 may determine one or more network conditions such as network traffic, packet loss, noise, upload speeds, download speed, combinations thereof, and the like. For example, the network condition component 116 may adjust a change in direction threshold required to determine an end of speech. For example, during periods when the network is experiencing high packet loss, the network condition component 116 may reduce one or more thresholds threshold so as to make it easier to detect an end of speech event.

The user device 111 may include a communication component 115 for providing an interface to a user to interact with the computing device 101. The communication component 115 may be any interface for presenting and/or receiving information to/from the user, such as user feedback. An interface may be communication interface such as a television (e.g., voice control device such as a remote, navigable menu or similar), web browser (e.g., Internet Explorer®, Mozilla Firefox®, Google Chrome®, Safari®, or the like). The communication component 115 may request or query various files from a local source and/or a remote source. The communication component 115 may transmit and/or data, such as audio content, telemetry data, network status information, and/or the like to a local or remote device such as the computing device 101. For example, the user device may interact with a user via a speaker configured to sound alert tones or audio messages. The user device may be configured to displays a microphone icon when it is determined that a user is speaking. The user device may be configured to display or otherwise output one or more error messages or other feedback based on what the user has said.

The computing device 101 may comprise an audio analysis component 102, a command component 103, a storage component 104, a communication component 105, a network condition component 106, a device identifier 107, a service element 108, and an address element 109. The communications component 105 may be configured to communicate with (e.g., send and receive data to and from) other devices such as the user device 111 via the network 120.

The audio analysis component 102 may be configured to receive audio data. The audio data may be received from, for example, the user device 111. For example, the user device 111 may comprise a voice enabled device. The user device 111 may comprise, for example, one or more microphones configured to detect audio. For example, a user may interact with the user device by pressing a button, speaking a wake word, or otherwise taking some action which activates the voice enabled device. The audio data may comprise or otherwise be associated with one or more utterances, one or more phonemes, one or more words, one or more phrases, one or more sentences, combinations thereof, and the like spoken by a user. The user device 111 may send the audio data to the computing device 101. The computing device 101 may receive the audio data (e.g., via the communications component 105). The computing device 101 may process the audio data. Processing the audio data may comprise analog to digital conversion, digital signal processing, natural language processing, natural language understanding, filtering, noise reduction, combinations thereof, and the like. Audio preprocessing can include determining direction of arrival, determining characteristics of an environment or analog signal such as reverberation, dereverberation, echoes, acoustic beamforming, noise reduction, acoustic echo cancellation, other audio processing, combinations thereof, and the like..

The audio analysis component 102 may include a machine learning model and/or one or more artificial neural networks trained to execute early exiting processes and/or the like. For example, the audio analysis component 102 may include and/or utilize a recurrent neural network (RNN) encoder architecture and/or the like. The audio analysis component 102 may be configured for automatic speech recognition (“ASR”). The audio analysis component 102 may apply one or more voice recognition algorithms to the received audio (e.g., speech, etc.) to determine one or more phonemes, phonetic sounds, words, portions thereof, combinations thereof, and the like. The audio analysis component 102 may convert the determined one or more phonemes, phonetic sounds, words, portions thereof, combinations thereof, and the like to text and compare the text to one or more stored phonemes, phonetic sounds, and/or words (e.g., stored in the storage component 104, etc.), such as operational commands, wake words/phrases, and/or the like. Operational command phonemes, phonetic sounds, and/or words, may be stored (e.g., stored in the storage component 104, etc.), such as during a device (e.g., the user device 101, etc.) registration process, when a user profile associated with the user device 101 is generated, and/or any other suitable/related method. The audio analysis component 102 may determine an operational command from the received audio by performing speech-to-text operations that translate audio content (e.g., speech, etc.) to text, other characters, or commands.

The audio analysis component 102 may comprise an automatic speech recognition (“ASR”) systems configured to convert speech into text. As used herein, the term “speech recognition” refers not only to the process of converting a speech (audio) signal to a sequence of words or a representation thereof (text), but also to using Natural Language Understanding (NLU) processes to understand and make sense of a user utterance. The ASR system may employ an ASR engine to recognize speech. The ASR engine may perform a search among the possible utterances that may be spoken by using models, such as an acoustic model and a language model. In performing the search, the ASR engine may limit its search to some subset of all the possible utterances that may be spoken to reduce the amount of time and computational resources needed to perform the speech recognition. ASR may be implemented on the computing device 101, on the user device 111, or any other suitable device. For example, the ASR engine may be hosted on a server computer that is accessible via a network. Various client devices may transmit audio data over the network to the server, which may recognize any speech therein and transmit corresponding text back to the client devices. This arrangement may enable ASR functionality to be provided on otherwise unsuitable devices despite their limitations. For example, after a user utterance is converted to text by the ASR, the server computer may employ a natural language understanding (NLU) process to interpret and understand the user utterance. After the NLU process interprets the user utterance, the server computer may employ application logic to respond to the user utterance. Depending on the translation of the user utterance, the application logic may request information from an external data source. In addition, the application logic may request an external logic process. Each of these processes contributes to the total latency perceived by a user between the end of a user utterance and the beginning of a response.

The command component 103 may receive the one or more utterances and/or the one or more portions of the one or more utterances. The command component 113 may be configured for NLP and/or NLU and may determine, for example, one or more keywords or key phrases contained in the one or more utterances. Based on the one or more keywords, the command component 103 may determine one or more operational commands. The computing device 101 may determine one or more operational commands. The one or more operational commands may comprise one or more channels, one or more operations (e.g., “tune to,” “record,” “play,” etc.), one or more content titles, combinations thereof, and the like. The command component 103 may determine whether a phoneme, phonetic sound, word, and/or words extracted/determined from the audio data match a stored phoneme, phonetic sound, word, and/or words associated with an operational command of the one or more operational commands. The command component 103 may determine whether the audio data includes a phoneme, phonetic sound, word, and/or words that correspond to and/or are otherwise associated with the operational command.

The network condition component 106 may be configured to one or more thresholds related to determining the end of speech (e.g., change in direction, change in volume) based on network conditions. For example, the network condition component 106 may determine one or more network conditions such as network traffic, packet loss, noise, upload speeds, download speed, combinations thereof, and the like. For example, the network condition component 106 may adjust a change in direction threshold required to determine an end of speech. For example, during periods when the network is experiencing high packet loss, the network condition component 106 may reduce one or more thresholds threshold so as to make it easier to detect an end of speech event.

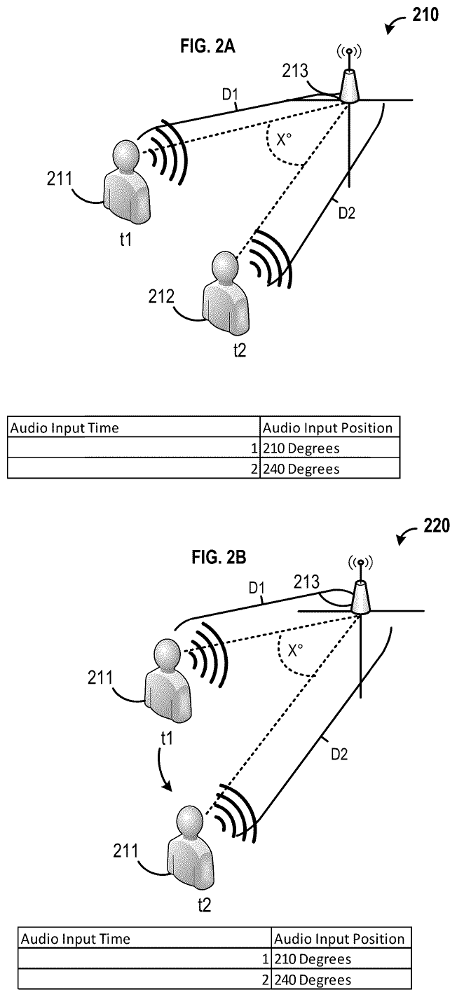

FIG. 2A shows a multiuser scenario wherein a first user 211 may speak a first portion of audio. The user device 213 may determine spatial information such as a direction associated a source of the first portion of the audio (e.g., a direction of arrival). For example, the user device 213 may determine phase, direction of arrival, time difference direction of arrival, combinations thereof, and the like. For example, it may be determined that the source of the first portion of the audio is at 210 degrees. The first portion of audio may comprise a wake word, one or more voice commands, combinations thereof, and the like. After receiving the first portion of audio, the user device may detect a second portion of audio. Spatial information associated with the second portion of audio may be determined. For example, it may be determined that the second portion of audio originated from a source at 240 degrees. The spatial information associated with the first portion of the audio and the second portion of the audio may be compared. For example, the direction of origin of the first portion of audio and the second portion of audio may be determined. The difference may be compared to a direction threshold. If the difference satisfies the direction threshold, it may be determined the first source and the second source are two different sources. For example, the first portion of the audio may comprise a wake word, and thus the first source may be determined to be a desired source or a target source and the second source may be determined to be an undesired or non-target or interrupting source. Based on determining the second portion of audio originated a non-target source, the second portion of audio may not be processed. A time stamp associated with the second portion of audio may be determined. Audio processing of the first portion may be terminated based on the time stamp associated with the second portion.

Similarly, a distance from the user device 213 may be determined, based on, for example, the received power level (e.g., the volume, magnitude, amplitude) of the first portion of audio. For example, the received wake word from the target speaker may be compared to an audio profile associated with the target speaker speaking the wake word at a known distance. The distance may also be determined without reference to historical audio data. For example, reverberation data may be determined (e.g., decay, critical distance, T₆₀ time) and used to determine a position of the audio source. For example, reverberation increases with source distance from a microphone. Therefore, the degree of reverberation may be used to distinguish between two source or a single source that has changed locations. Further, a room impulse response (e.g., Cepstrum analysis, linear prediction) may be determined. The room impulse response is what a microphone would receive when an impulse (e.g., a sound) is played. An impulse is a sound of very short duration. A microphone receives that single sample plus all the reflections of it as a result of the room characteristics.

Timing information associated with the first portion of audio and the second portion of audio. For example, a first time associated with detection of the first portion may be determined and a second time associated with the second portion of audio may be determined. Based on the timing information and the position information, it may be determined that the first portion of audio originated from a first source (e.g., the first user 211, the target user) and the second portion of audio originated from a second source (e.g., the second user 212, the non-target user).

FIG. 2B shows a single user scenario 220 wherein a first user 211 speaks a first portion of audio at a first time t1. A user device 213 may receive the first portion of the audio and determine audio data associated with the first portion of the audio data. For example, the user device 213 may determine spatial information such as a direction associated a source of the first portion of the audio (e.g., the first user 211). For example, the user device 213 may determine a direction of arrival associated with the first portion. The first portion may comprise a wake word, one or more utterances, one or more voice commands, combinations thereof, and the like. For example, if the first portion of audio comprises the wake word, it may be determined that the source of the first portion of audio is the target source. A received signal level (e.g., volume, power) associated with the first portion of audio may be determined. A distance (D1) between the source of the first portion of audio and the user device 213 may be determined. For example, the received signal power of the first portion of the audio may be compared to a profile associated with the source of the first portion (e.g., a user profile). The user profile may indicate a preconfigured distance and volume associated with the user speaking the wake word. The preconfigured distance and volume may be compared to the volume of the received first portion in order to determine D1.

The user device 213 may (for example, at a second time t2) detect a second portion of audio. The first portion of audio and the second portion of audio may be part of an audio input comprising one or more portions of audio. A direction of arrival associated with the second portion or audio may be determined. The direction of arrival associated with the first portion of audio and the direction of arrival of the second portion of audio may be compared and a difference determined. For example, it may be determined the source of the first portion of audio originated from a source at 210 degrees. For example, it may be determined that the second portion of audio originated from a source at 240 degrees. The difference (e.g., 30 degrees) may be compared to a direction of arrival difference threshold. If the difference satisfies the threshold, the second portion of the audio may not be processed and/or audio processing of the second portion of the audio may be terminated. A second distance (D2) between the source of the second portion of audio and the user device may be determined. For example, it may be determined (e.g., based on a user profile) that the source of the first portion of audio of audio and the source of the second portion of audio are the same (e.g., the same user). D2 may be compared to D1. For example, D1 may be 5 feet and D2 may be 10 feet. The respective distances at t1 and t2, along with the direction of arrival may be used to determine a change in position (e.g., absolute position, position relative to the user device 213).

A second portion of the audio input may be determined. For example, the user device 213 may determine (e.g., detect, receive) a second portion of the audio input. The second portion of the audio input may or may not originate from the same speaker as the first portion of the audio input. In scenario 210, the second portion of the audio input originates from the user 212. The user device may determine a second direction associated with the second portion of the audio input. The second portion of the audio input may or may not comprise an utterance. For example, the second portion of the audio input may comprise speech unrelated to the first portion of the audio input. A difference between the first direction associated with the first portion of the audio input the second direction associated with the second portion of the audio input may be determined.

The difference between the first direction and the second direction (first position, second position, first distance, second distance, first position, second position, combinations thereof, and the like), may be compared to one or more thresholds. The difference between the first direction and the second direction may satisfy the one or more thresholds. For example, in scenario 210, the thirty degree difference may satisfy a threshold of 20 degrees. Processing the audio input may be terminated based on the difference between the first direction and the second direction satisfying the threshold.

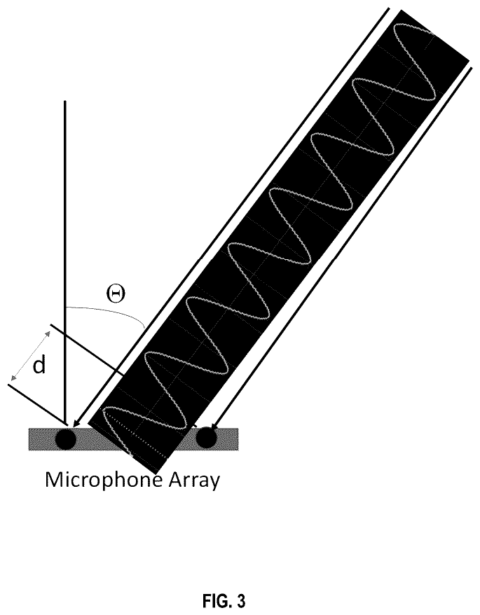

FIG. 3 shows an example diagram 300. In the diagram, an incoming sound wave is detected by one or more microphones making up a microphone array. The incoming sound wave may originate from, for example a user. The incoming sound wave may be associated with a wake work. The incoming sound wave may be associated with one or more frequencies, subfrequencies, bands, subbands, combinations thereof, and the like.

The incoming sound wave may arrive at the first microphone with a first phase. The incoming sound wave may arrive at the second microphone with a second phase. A difference in phase may be determined between the first phase and the second phase. The phase difference may be greater for higher frequencies and smaller for lower frequencies. The phase difference may be determined for the center frequency and any one or more subfrequencies or constituent frequencies (e.g., as determined by Fourier analysis). Based on the phase difference and the frequency, a time difference of arrival may be determined. Based on the time difference of arrival, the direction of arrival with respect to each microphone may be determined. The direction of arrival of the audio in each frequency band may be determined based on the phase difference, the center frequency of the band, and the geometry of the microphones. For example, the phase difference varies slower as a function of direction of arrival compared to the phase difference at higher frequencies. Similarly, the phase difference increases as the spacing between a pair of microphones increases.

For example, audio may be sampled at 16,000 samples per second. Given the speed of sound, the sampling period of 1/16,000 corresponds to a distance travelled of about 2.1 centimeters. A distance between any of the one or more microphones may be determined. For example, the distance may be 2.1 cm. The frequency of the incoming sound wave may be 8 kHz sine wave. The incoming sound wave may be travelling from the left (90 degrees left of vertical) toward the one or more microphones. For example, the left microphone will receive each sample exactly one sample period before the right microphone. And because an 8 kHz tone sampled at 16 kHz has two samples per cycle, the phase difference between the two microphones will be 180 degrees. On the other hand, if the incoming audio signal arrives from −90 degrees, the phase difference will be −180 degrees.

Similarly, for a 2 kHz tone, which has 8 samples per cycle, the phase difference at 90 degrees will be 180/4 degrees and the phase difference at −90 degrees will be −180/4 degrees. As the angle of arrival varies between 90 and −90 degrees, the phase difference varies in a predictable way for any given frequency and thus a direction may be determined.

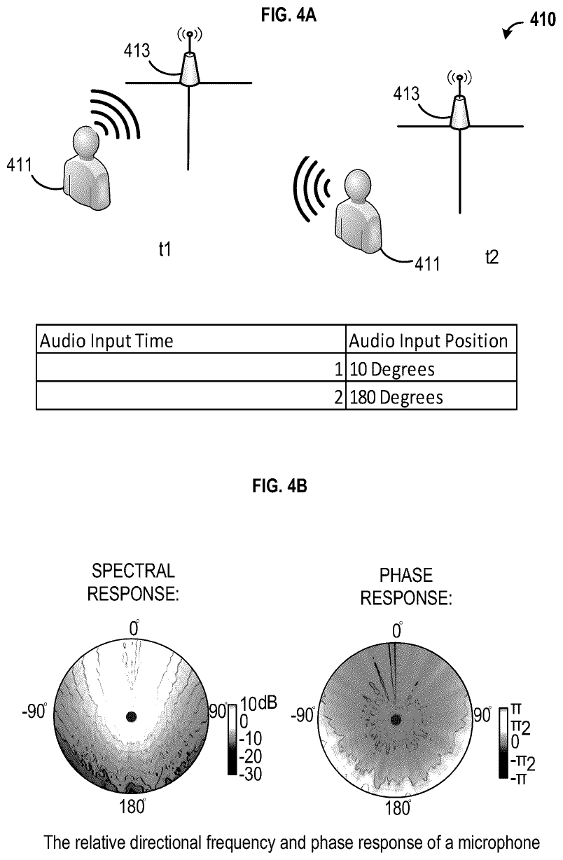

FIG. 4A shows single user scenario 410. A user device 413 may detect an audio input. For example, the audio input may comprise one or more portions. The user device 413 may detect a first portion of the audio input at time t1. The user device 413 may receive the first portion of the audio and determine audio data associated with the first portion of the audio data. For example, the user device 413 may determine spatial information such as a direction associated a source of the first portion of the audio (e.g., the first user 411). For example, the user device 413 may determine a direction of arrival associated with the first portion. The first portion may comprise a wake word, one or more utterances, one or more voice commands, combinations thereof, and the like. For example, if the first portion of audio comprises the wake word, it may be determined that the source of the first portion of audio is the target source. A received signal level (e.g., volume, power) associated with the first portion of audio may be determined. A distance (D1) between the source of the first portion of audio and the user device 413 may be determined. For example, the received signal power of the first portion of the audio may be compared to a profile associated with the source of the first portion (e.g., a user profile). The user profile may indicate a preconfigured distance and volume associated with the user speaking the wake word. The preconfigured distance and volume may be compared to the volume of the received first portion in order to determine D1. The user device 413 may determine spectral information associate with the first portion of audio. The spectral information may be a frequency response indicating a receive level of one or more frequencies making up the first portion.

At a second time (t2), the user device 413 may detect a second portion of audio. The first portion of audio and the second portion of audio may be part of an audio input comprising one or more portions of audio. A direction of arrival associated with the second portion or audio may be determined. Similarly, spectral information associated with the second portion of audio may be determined. The spectral information may be a frequency response indicating a receive level of one or more frequencies making up the first portion.

A difference in the spectral information associated with the first portion of audio and the spectral information associated with the second portion of audio may be determined. For example, the frequency response of a speaker's voice received by a microphone may change as a function of the angle with respect to the microphone at which the user is speaking. For example, the frequency response when the user faces the microphone will be different than when the user faces to the left or right of the microphone. Thus, it may be determined, based on a change in the frequency response, whether or not the user is facing the user device 413, and by extension, whether the user intends to speak to the user device 413.

One or more actions may be caused based on the difference in the spectral information associated with the first portion of audio and the spectral information associated with the second portion of audio. For example, the second portion of audio may not be processed and/or processing of the second portion of audio may be terminated. For example, it may be determined that, because the user turned their head when speaking, the user was not intending to speak to the user device 413. Thus, an end of speech may be determined.

FIG. 4B shows a diagram indicating a change in spectral response as a function of a change in direction of arrival (e.g., a change in the orientation of a user's mouth with respect to the user device 413). For example, spectral information associated with the first portion of audio and the second portion of audio may be determined. The spectral information may be a frequency response indicating a receive level of one or more frequencies making up the first portion. A difference in the spectral information associated with the first portion of audio and the spectral information associated with the second portion of audio may be determined. For example, the frequency response of a speaker's voice received by a microphone may change as a function of the angle with respect to the microphone at which the user is speaking. For example, the frequency response when the user faces the microphone will be different than when the user faces to the left or right of the microphone. Thus, it may be determined, based on a change in the frequency response, whether or not the user is facing the user device, and by extension, whether the user intends to speak to the user device.

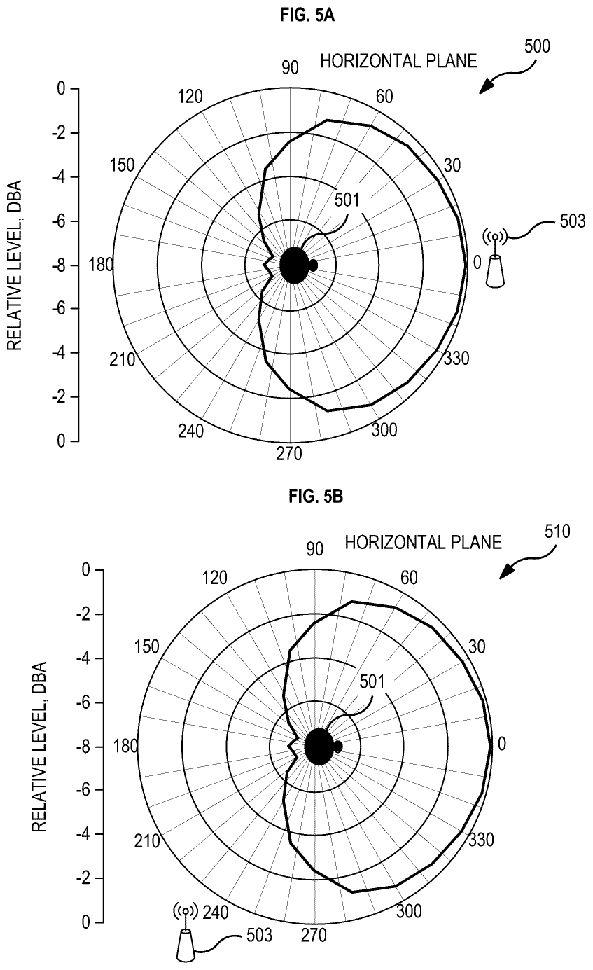

FIG. 5A shows an example diagram 500. The diagram 500 shows a user 501 and user device 503 at time tl. FIG. 5B shows an example diagram 510. Diagram 510 shows user 501 and user device 503 at time t2. Both FIGS. 5A and 5B show top views (e.g., horizontal plane) of the user 501 and one or more relative sound levels (e.g., one or more relative dBA levels) as measured at one or more distances and one or more angles relative to a user's mouth. As can be seen in FIGS. 5A and 5B, the highest dBAs are measured directly in front of (e.g., at 0 degrees with respect to) the user's mouth while the lowest decibels are measured behind the user's head (e.g., 180 degrees from the mouth). For example, in FIG. 5A, the sound registered at the user device 503 position at 0 degrees may measure at a first decibel level. However, as seen in FIG. the sound registered at the user device 503 when it is positioned at 240 degrees relative to the user's mouth may be −7 decibels relative to the first decibel level. FIG. 5B shows the user 501 and the user device 503 at time t2. Thus, the present systems and methods may determine a difference in a relative sound level between time t1 and time t2 and, based on the difference in the relative sound level, determine an end of speech as the user is no longer “talk to” (e.g., directing their voice at) the user device 503.

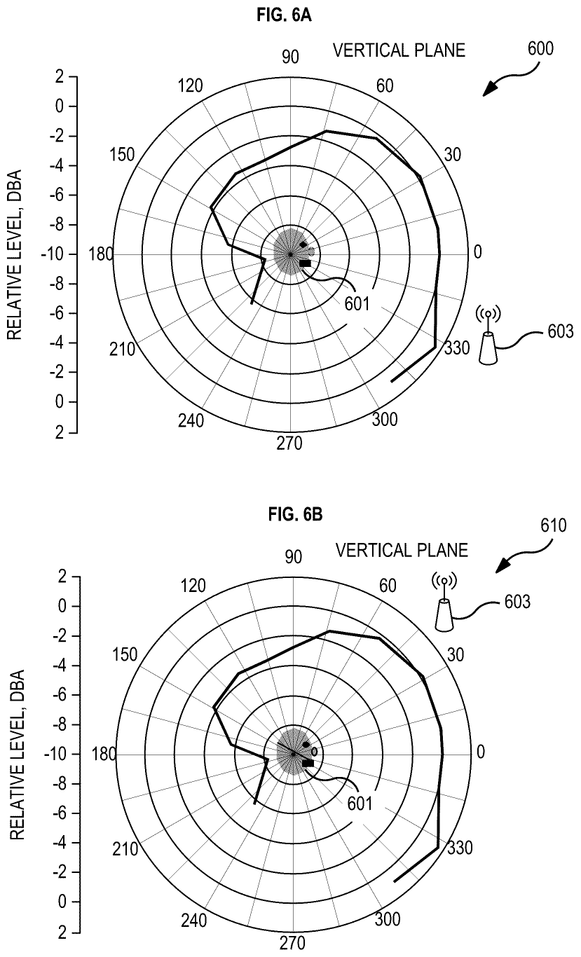

FIGS. 6A shows an example diagram 600. The diagram 600 shows a user 601 and user device 603 at time t1. FIG. 6B shows an example diagram 610. Diagram 610 shows user 601 and user device 603 at time t2. Both FIGS. 6A and 6B show side views (e.g., vertical plane) of the user 601 and one or more relative sound levels (e.g., one or more relative dBA levels) as measured at one or more distances and one or more angles relative to a user's mouth. As can be seen in FIGS. 6A and 6B, the highest dBAs are measured slightly below (e.g., at 330 degrees with respect to) the user's mouth while the lowest decibels are measured behind the user's head (e.g., 180 degrees from the mouth). For example, in FIG. 6A, the sound registered at the user device 603 positioned at 330 degrees may measure at a first decibel level. However, as seen in FIG. 6B, the sound registered at the user device 603 when it is positioned at 45 degrees relative to the user's mouth may be −2 decibels relative to the first decibel level. FIG. 6B shows the user 601 and the user device 603 at time t2. Thus, the present systems and methods may determine a difference in a relative sound level between time t1 and time t2 and, based on the difference in the relative sound level, determine an end of speech as the user is no longer “talking to” (e.g., speaking directly at) the user device 603.

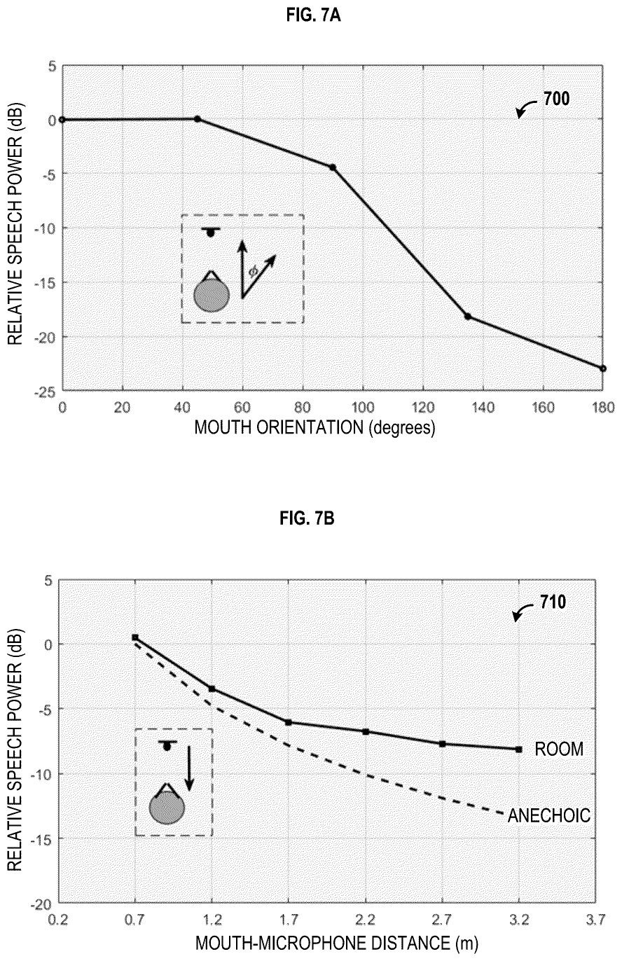

FIGS. 7A and 7B show example diagrams 700 and 710. Diagram 700 shows relative speech power as a function of mouth orientation with respect to a user device (e.g., and/or a microphone on the user device). For example, diagram 700 shows that as mouth orientation varies with respect to the microphone (e.g., move from 0 degrees to 180 degrees), the relative speech power (e.g., decibels) measured at the microphone decrease. Diagram 710 shows that as a distance from a mouth of a user and a microphone of the user device increase, the relative speech power (e.g., decibels) decreases. Further, diagram 710 shows that the characteristics of a space impact the relationship between relative speech power and mouth-microphone distance. For example, in an anechoic chamber, the decrease in relative speech power as a function of mouth-microphone distance is greater than in a standard room. The present systems and methods may make use of acoustics to adjust one or more thresholds related to determining the end of speech.

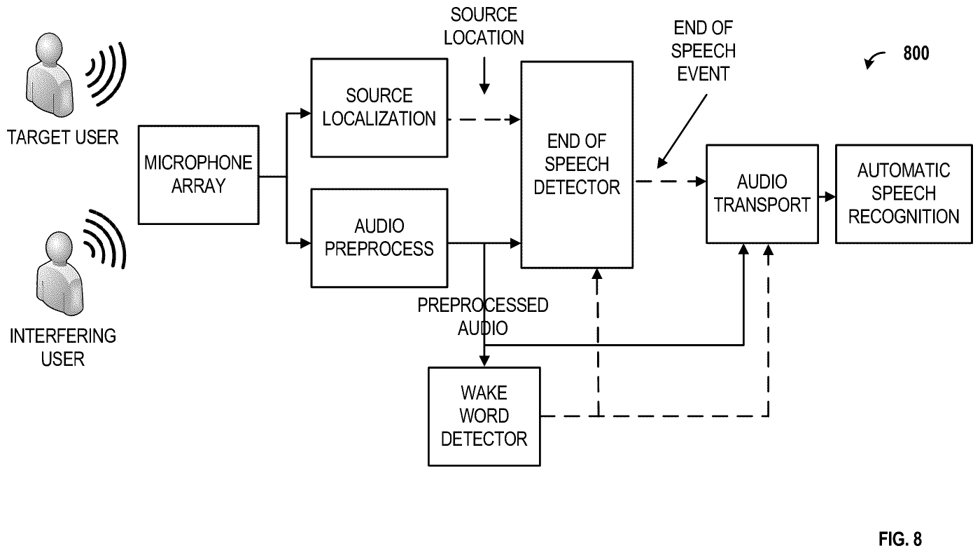

FIG. 8 shows an example system 800. The disclosed system makes use of source localization to distinguish the locations of the audio sources in the room. Once a desired talker location is identified (perhaps while speaking a wake-word,) the measured direction of arrival at one or more time intervals is sent to a speech detector to determine whether or not the “desired talker” is speaking.

For example, the desired talker may speak a command while an interfering talker is also speaking and continues to speak past the end of the desired talker's command. If direction of arrival information is available, the interferer's speech that continues past the end of the desired talker's command will be rejected by the “desired talker detector”.

The present system does not require multiple speech detectors operating on multiple separated sources and there is no need to perform blind source separation. The end of speech algorithm gains the benefit of source location information without risking the distortion caused by blind source separation. The end of speech detector determines source location on a frame by frame basis.

A location-enhanced end of speech detector may be used in conjunction with other techniques such as acoustic beamforming and even blind source separation. In the latter case, the location-enhanced end of speech detector can use the source location more aggressively whereas the blind source separation algorithm can use the source location information less aggressively, avoiding excessive audio artifacts.

The desired talker's speech and interfering talker's speech feed a microphone array. The multichannel output of the microphone array may be input to both a source localization algorithm and an audio preprocessing algorithm. The audio preprocessing algorithm may clean up (e.g., filter) the audio. Audio preprocessing can include acoustic beamforming, noise reduction, dereverberation, acoustic echo cancellation and other algorithms. (An echo canceller reference signal isn't shown here in order to simplify the diagram.)

The preprocessed audio may fed to the wake word detector and the end of speech detector. Between these two detectors, the system may determine at what point in time to begin streaming audio to the automatic speech recognition device. Typically the command that follows the wake word is sent. For example, if the user speaks “Hey Xfinity, watch NBC”, “watch NBC” would be streamed to the speech recognition device. So the stream would start upon the end of wake word event and continue through the end of speech event.

The source localization block provides additional information (current source location) to the end of speech detector to help determine the end of speech. More specifically, the end of speech detector monitors the direction of arrival information, keeping track of recent history (e.g., about one second). When the wake word detector detects the wake word, the end of speech detector may determine (e.g., estimate) the direction of arrival of the desired talker by looking at the direction of arrival history. From that point forward, the end of speech detector may qualify its speech detector frame-by-frame decision with the current direction of arrival information.

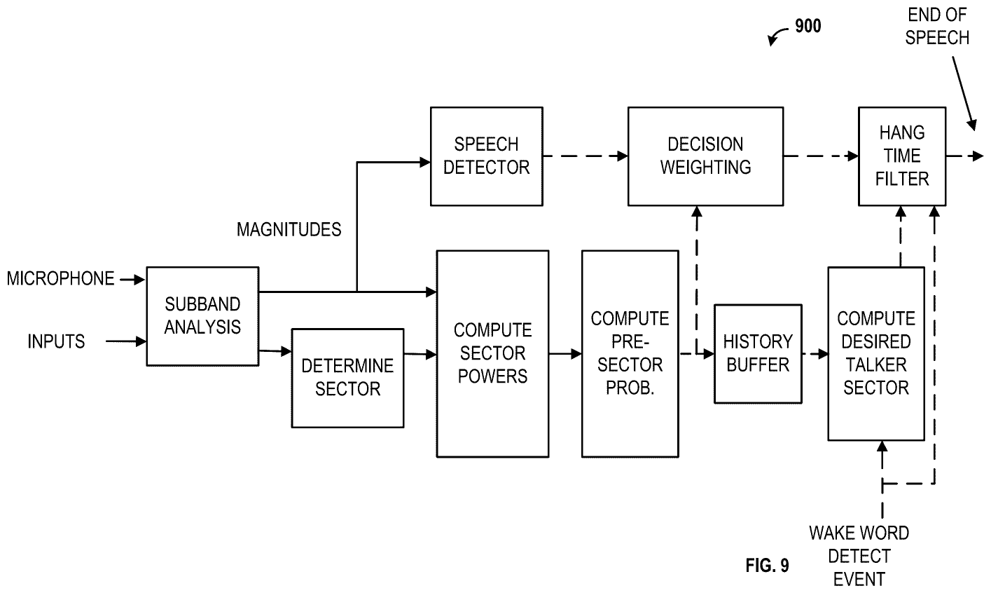

FIG. 9 shows an example system 900. The system 900 may comprise an end of speech detector. The microphone inputs may be sent to a subband analysis block, which may convert the input signals to the frequency domain, dividing the audio into N frequency bands (e.g., 256). Operating in the subband domain may improve both source localization and speech detection. For each frame of audio from each microphone (e.g., 256 samples in duration), the subband analysis block may output N complex samples—one for each frequency band.

For the purpose of source localization, a space may be divided into S sectors where each sector represents a range of direction of arrival with respect to the microphone array. The sectors may have one, two, and/or three dimensions (and the time domain).

The phase information may be sent to the “Determine Sector” block, which may determine the direction of arrival of each frequency bin and then quantize the direction of arrival into one of a set of S sectors. Using the sector information of each frequency bin and the magnitude of each frequency bin, the per-sector per-frequency bin powers may be determined by the Compute Sector Powers block. The sector powers are sent to the Compute per Sector Probability block, which may determine the relative probability that there is a source emanating from each sector. The sector short term history of sector powers is stored in the History Buffer.

Upon a wake word detect event, the Compute Desired Talker Sector block may analyze the contents of the history buffer to determine the most likely sector from which the desired talker's audio is emanating. Also, upon the wake word detect event, the hang time filter's timer may be reset to zero.

A microphone's per-frequency-bin magnitudes may be selected. The magnitudes may be sent to one of the classic speech detectors. The output of the speech detector (which computes a per-frame speech presence decision) may be weighted based upon the current sector probabilities and the known desired talker's speech sector. The weighted decision may be sent to the hang time filter, which filters out inter-syllable and inter-word gaps in the desired talker's speech. When the hang timer expires (exceeds a duration threshold), end of speech is declared. If speech resumes (after an inter-word gap yet prior to end of speech) while the hang timer is non-zero, the timer counter can be reset to zero or decremented in some intelligent fashion.

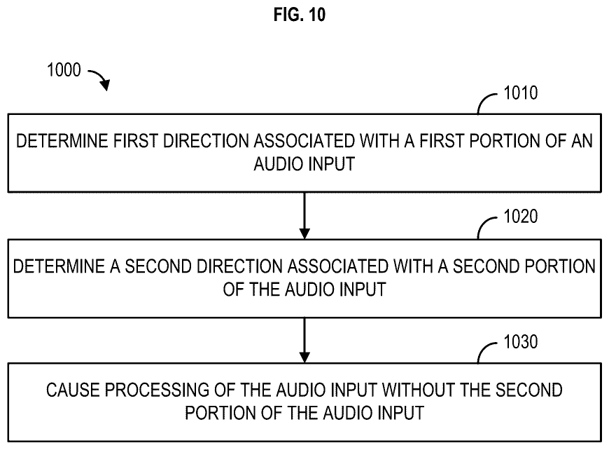

FIG. 10 is a flowchart of an example method 1000. The method may be carried out by any one or more devices, such as, for example any one of more devices described herein. At 1010 based on a first portion of an audio input, a first direction associated with the first portion of the audio input may be determined. Other spatial information associated with the first portion of the audio input may be determined. For example, a distance between a source of the first portion of the audio input and the user device may be determined. For example, the audio input may be received by a user device and/or a computing device. Either or both the user device and/or the computing device may be configured for NLP/NLU and may be configured to determine, based on a received audio input, one or more wake words, one or more utterances, one or more operational commands, combinations thereof, and the like. For example, the first portion of the audio input may comprise a wake word. The first direction associated with the first portion of the audio input may indicate a relative direction (e.g., in degrees, radians) from which the first portion of the audio input was received by a user device. For example, the user device may comprise a voice enabled device. The voice enabled device may comprise a microphone array. The microphone array may comprise one or more microphones. The direction of the first portion of the audio input may be determined based on timing data and/or phase data associated with the first portion of the audio input as described herein. For example, a time difference of arrival (e.g., TDOA) may be determined. For example, a first phase associated with the first portion of the audio input may be determined. For example, a first microphone of the one or more microphones may detect (e.g., receive, determine, encounter) the first portion of the audio input at a first time and a second microphone of the one or more microphones may detect the first portion of the audio input at a second time (e.g., after the first microphone). As such, it may be determined the source of the first portion of the audio input is closer to (e.g., in the direction of) the first microphone.

At 1020, a second direction associated with a second portion of the audio input may be determined. For example, the second portion of the audio input may comprise an utterance such as a command. The first direction associated with the first portion of the audio input may indicate a relative direction (e.g., in degrees) from which the first portion of the audio input was received by a user device. For example, the user device may comprise a voice enabled device. The voice enabled device may comprise one or more microphones. The direction of the first portion of the audio input may be determined based on phase data associated with the first portion of the audio input as described herein. For example, a time difference of arrival (e.g., TDOA) may be determined. For example, the second microphone of the one or more microphones may detect (e.g., receive, determine, encounter) the second portion of the audio input at third first time and the first microphone of the one or more microphones may detect the second portion of the audio input at a fourth time (e.g., after the second microphone). As such, it may be determined the source of the second portion of the audio input is closer to (e.g., in the direction of) the second microphone.

For example an incoming sound wave is detected by one or more microphones making up a microphone array. The incoming sound wave may originate from, for example a user. The incoming sound wave may be associated with a wake work. The incoming sound wave may be associated with one or more frequencies, subfrequencies, bands, subbands, combinations thereof, and the like.

The incoming sound wave may arrive at the first microphone with a first phase. The incoming sound wave may arrive at the second microphone with a second phase. A difference in phase may be determined between the first phase and the second phase. The phase difference may be greater for higher frequencies and smaller for lower frequencies. The phase difference may be determined for the center frequency and any one or more subfrequencies or constituent frequencies (e.g., as determined by Fourier analysis). Based on the phase difference and the frequency, a time difference of arrival may be determined. Based on the time difference of arrival, the direction of arrival with respect to each microphone may be determined. The direction of arrival of the audio in each frequency band may be determined based on the phase difference, the center frequency of the band, and the geometry of the microphones. For example, the phase difference varies slower as a function of direction of arrival compared to the phase difference at higher frequencies. Similarly, the phase difference increases as the spacing between a pair of microphones increases.

Spectral information associated with the first portion of audio and the second portion of audio may be determined. The spectral information may be a frequency response indicating a receive level of one or more frequencies making up the first portion. A difference in the spectral information associated with the first portion of audio and the spectral information associated with the second portion of audio may be determined. For example, the frequency response of a speaker's voice received by a microphone may change as a function of the angle with respect to the microphone at which the user is speaking. For example, the frequency response when the user faces the microphone will be different than when the user faces to the left or right of the microphone. Thus, it may be determined, based on a change in the frequency response, whether or not the user is facing the user device, and by extension, whether the user intends to speak to the user device. For example, when a user intends to speak to the user device, the user may look at and/or speak towards the user device. Thus, certain the spectral frequency information determined by the user device may indicate the user is speaking at the user device. On the other hand, when the user is speaking but not looking at the user device, the spectral frequency information may be different, and thus determined that the user does not intend to speak to the user device.

One or more actions may be caused based on the difference in the spectral information associated with the first portion of audio and the spectral information associated with the second portion of audio. For example, the second portion of audio may not be processed and/or processing of the second portion of audio may be terminated. For example, it may be determined that, because the user turned their head when speaking, the user was not intending to speak to the user device. Thus, an end of speech may be determined.

At 1030, processing of the audio input without the second portion of the audio input may be caused. For example, processing of the audio input without the second portion of the audio input may be caused based on a difference between the first direction and the second direction. It may be determined that the difference between the first direction and the second direction satisfies a threshold. Processing of the audio input without the second portion of the audio input may comprise not sending the second portion of the audio input for processing. Processing may comprise natural language processing, natural language understanding, speech recognition, speech to text transcription, determining one or more queries, determining one or more commands, executing one or more queries, executing one or more commands, sending or receiving data, combinations thereof, and the like.

The method may comprise causing a termination of audio processing. For example, the termination of the audio processing may be caused based on the second direction associated with the second portion of the audio input. For example, the second direction may be different from the first direction. For example, the difference in direction between the first direction associated with the first portion of the audio input and the second direction associated with the second portion of the audio input may satisfy one or more thresholds. The termination of audio processing may be caused based on a difference in phase data. For example, a difference in phase between the first portion of the audio input and the second portion of the audio input. The phase difference may be determined to satisfy a threshold. For example, a threshold of the one or more thresholds may indicate a quantity of degrees (e.g., 10 degrees, 30 degrees, one or more radians, etc . . . ) and, if the second direction is equal to or greater than the threshold for a period of time, the audio processing may be terminated.

The method may comprise outputting a change of direction indication. For example, the user device may output the change of direction indication. The method may comprise causing a termination of one or more one or more audio processing functions such as closing a communication channel.

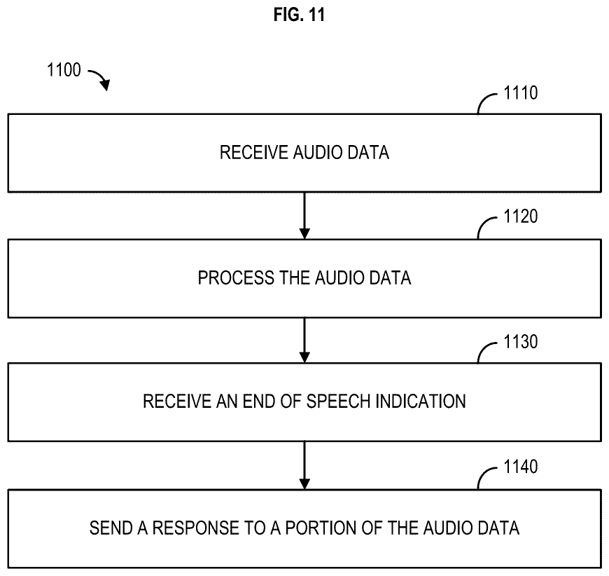

FIG. 11 is a flowchart of an example method 1100. The method may be carried out on any one or more devices as described herein. At 1110, audio data may be received. For example, the audio data may be received by a computing device from a user device. The audio data may be the result of digital processing of an analog audio signal (e.g., one or more soundwaves). The audio signal may originate from an audio source. The audio source may, for example, be a target user and/or an interfering user. The user device may be associated with the audio source. For example, the user device may be a registered device associated with a user device identifier, a user identifier, a user profile, combinations thereof, and the like. For example, the user device may be owned by the target user and/or otherwise registered to the target user (e.g., associated with a user ID).

The user device may be configured to recognize the target user. For example, the user device may be configured with voice recognition. For example, either or both of the user device and/or the computing device may be configured for NLP/NLU and may be configured to determine, based on a received audio input, one or more wake words, one or more utterances, one or more operational commands, combinations thereof, and the like. The user device may comprise a voice enabled device. The user device may comprise a microphone array. The microphone array may comprise one or more microphones. The user device may be associated with the audio source.

At 1120, the audio data may be processed. Processing the audio data may comprise determining one or more audio inputs. The one or more audio inputs may comprise one or more portions. The one or more audio inputs may comprise one or more user utterances. The one or more user utterances may comprise one or more wake words, one or more operational commands, one or more queries, combinations thereof, and the like. Processing the audio data may comprise performing (e.g., executing) the one or more operational commands, sending the one or more queries, receiving one or more responses, combinations thereof, and the like. Processing the audio data may comprise sending the audio data, including transcriptions and/or translations thereof, to one or more computing devices.

At 1130, an end of speech indication may be received. The end of speech indication may indicate an end of speech. For example, the end of speech indication may indicate that a user is done speaking. The end of speech indication may be determined bas on a change spatial information associated with the audio source. For example, the end of speech indication may be determined based on a change in location of the audio source, a change in direction of one or more portions of an audio input associated with the audio source, a change of phase between one or more portions of the audio input associated with the audio source. The end of speech indication may be determined based on a period of time after the end of a user utterance.

At 1140, a response may be sent. The response may be a response to a portion of the audio data. The portion of the audio data may comprise a portion of the audio data received before the end of speech indication. For example, the response to the portion of the audio data received before the end of speech indication may be sent based on the end of speech indication.

The method may comprise causing processing of the audio data to be terminated. Processing the audio data may be terminated based on the end of speech indication. For example, a communication session may be terminated, a query not sent, a response to a query ignored, ASR and/or NLU/NLP may be terminated, combinations thereof, and the like. Processing the audio data may comprise one or more of: natural language processing, natural language understanding, speech recognition, speech to text transcription, determining one or more queries, determining one or more commands, executing one or more queries, sending or receiving data, executing one or more commands, combinations thereof and the like. The method may comprise sending a change of direction indication to the user device. The method may comprise sending a termination confirmation message.

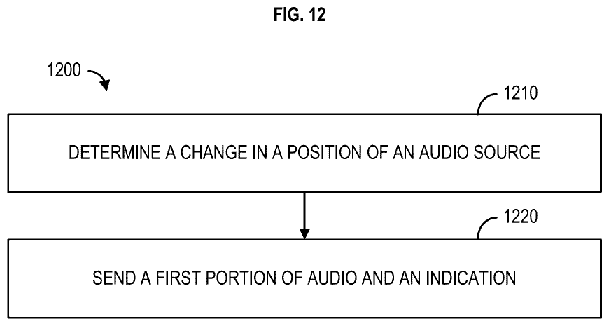

FIG. 12 is a flowchart of an example method 1200 for voice control. The method may be carried out on any one or more of the devices as described herein. At 1210, based on first phase data associated with a first portion of an audio input and second phase data associated with a second portion of the audio input, a change in a position of an audio source associated with the audio input. The audio input may be received by a user device. The user device may comprise a voice enabled device. The first portion of the audio input may comprise, for example, one or more portions of a wake word. The user device may be associated with the audio source. For example, the user device may be a registered device associated with a user device identifier, a user identifier, a user profile, combinations thereof, and the like. For example, the user device may be owned by the target user and/or otherwise registered to the target user (e.g., associated with a user ID).

The user device may be configured to recognize the target user. For example, the user device may be configured with voice recognition. For example, either or both of the user device and/or the computing device may be configured for NLP/NLU and may be configured to determine, based on a received audio input, one or more wake words, one or more utterances, one or more operational commands, combinations thereof, and the like. The user device may comprise a voice enabled device. The user device may comprise a microphone array. The microphone array may comprise one or more microphones.

For example, the change in the position of the audio source may be determined based on a difference between the first phase data associated with the first portion of the audio input and the second phase data associated with the second portion of the audio input. For example, an incoming sound wave associated with the first portion of the audio input may arrive at the first microphone with a first phase. The incoming sound wave may arrive at the second microphone with a second phase. A difference in phase may be determined between the first phase and the second phase. The phase difference may be greater for higher frequencies and smaller for lower frequencies. The phase difference may be determined for the center frequency and any one or more subfrequencies or constituent frequencies (e.g., as determined by Fourier analysis). Based on the phase difference and the frequency, a time difference of arrival may be determined. Based on the time difference of arrival, the direction of arrival with respect to each microphone may be determined. The direction of arrival of the audio in each frequency band may be determined based on the phase difference, the center frequency of the band, and the geometry of the microphones. For example, the phase difference varies slower as a function of direction of arrival compared to the phase difference at higher frequencies. Similarly, the phase difference increases as the spacing between a pair of microphones increases.

Spectral information associated with the first portion of audio and the second portion of audio may be determined. The spectral information may be a frequency response indicating a receive level of one or more frequencies making up the first portion. A difference in the spectral information associated with the first portion of audio and the spectral information associated with the second portion of the audio may be determined. For example, the frequency response of a speaker's voice received by a microphone may change as a function of the angle (for example, with respect to the microphone) at which the user is speaking. For example, the frequency response when the user faces the microphone will be different than when the user faces to the left or right of the microphone, or above or below the microphone. Thus, it may be determined, based on a change in the frequency response, whether or not the user is facing the user device, and by extension, whether the user intends to speak to the user device.

One or more actions may be caused based on the difference in the spectral information associated with the first portion of audio and the spectral information associated with the second portion of audio. For example, the second portion of audio may not be processed and/or processing of the second portion of audio may be terminated. For example, it may be determined that, because the user turned their head when speaking, the user was not intending to speak to the user device. Thus, an end of speech may be determined.

Similarly, a distance from the user device may be determined, based on, for example, the received power level (e.g., the volume, magnitude, amplitude) of the first portion of audio. For example, the received wake word from the target speaker may be compared to an audio profile associated with the target speaker speaking the wake word at a known distance. The distance may also be determined without reference to historical audio data. For example, reverberation data may be determined (e.g., decay, critical distance, T₆₀ time) and used to determine a position of the audio source. For example, reverberation increases with source distance from a microphone. Therefore, the degree of reverberation may be used to distinguish between two sources or a single source that has changed locations. Further, a room impulse response (e.g., Cepstrum analysis, linear prediction) may be determined.

At 1220, the first portion of the audio input may be sent. At 1220, an indication that the first portion of the audio input comprises an end of speech may be sent. For example, the user device may send the first portion of the audio input and the indication that the first portion of the audio input comprises an end of speech may be sent to a computing device.

The method may comprise excluding from processing or terminating processing of the second portion of the audio. For example, the second audio data may not be processed based on the change in the relative position of the source of the audio input. For example, the change in the relative position of the source of the audio input may indicate that the second audio data did not originate from the same source as the first audio data and therefore, originated from a different speaker (e.g., not the same speaker that spoke the wake word). For example, processing the second audio data comprises one or more of: speech recognition, speech to text transcription, determining one or more queries, determining one or more commands, executing one or more queries, or executing one or more commands.

The method may comprising sending a change of direction notification. For example, the computing device may determine the change of direction and send the change of direction notification to the user device.

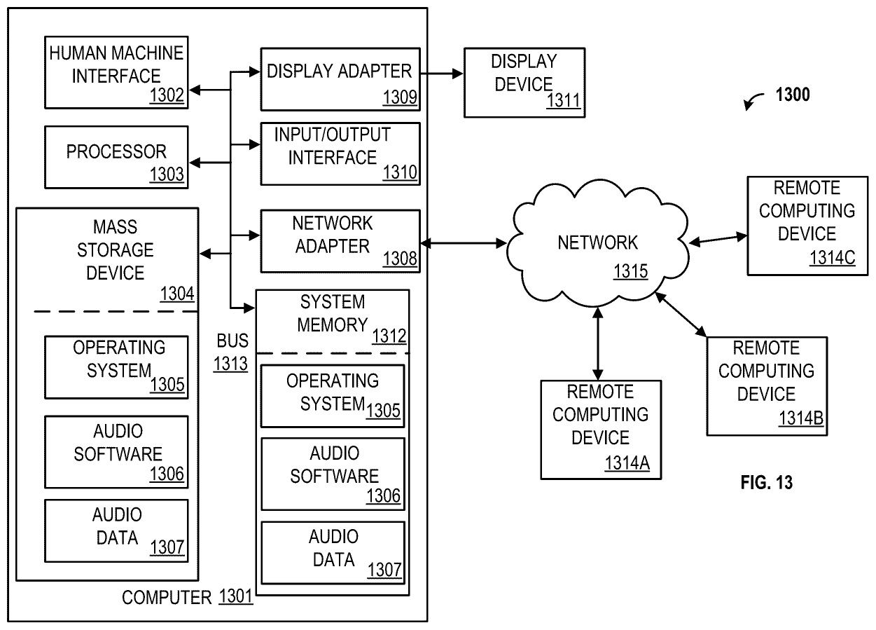

FIG. 13 shows a system 1300 for voice control. Any device and/or component described herein may be a computer 1301 as shown in FIG. 13.

The computer 1301 may comprise one or more processors 1303, a system memory 1312, and a bus 1313 that couples various components of the computer 1301 including the one or more processors 1303 to the system memory 1312. In the case of multiple processors 1303, the computer 1301 may utilize parallel computing.

The bus 1313 may comprise one or more of several possible types of bus structures, such as a memory bus, memory controller, a peripheral bus, an accelerated graphics port, and a processor or local bus using any of a variety of bus architectures.

The computer 1301 may operate on and/or comprise a variety of computer-readable media (e.g., non-transitory). Computer-readable media may be any available media that is accessible by the computer 1301 and comprises, non-transitory, volatile, and/or non-volatile media, removable and non-removable media. The system memory 1312 has computer-readable media in the form of volatile memory, such as random access memory (RAM), and/or non-volatile memory, such as read-only memory (ROM). The system memory 1312 may store data such as audio data 1307 and/or program components such as operating system 1305 and audio software 1306 that are accessible to and/or are operated on by the one or more processors 1303.

The computer 1301 may also comprise other removable/non-removable, volatile/non-volatile computer storage media. The mass storage device 1304 may provide non-volatile storage of computer code, computer-readable instructions, data structures, program components, and other data for the computer 1301. The mass storage device 1304 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program components may be stored on the mass storage device 1304. An operating system 1305 and audio software 1306 may be stored on the mass storage device 1304. One or more of the operating system 1305 and audio software 1306 (or some combination thereof) may comprise program components and the audio software 1306. Audio data 1307 may also be stored on the mass storage device 1304. Audio data 1307 may be stored in any of one or more databases known in the art. The databases may be centralized or distributed across multiple locations within the network 1315.

A user may enter commands and information into the computer 1301 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1303 via a human-machine interface 1302 that is coupled to the bus 1313, but may be connected by other interface and bus structures, such as a parallel port, game port, an IEEE 1394 Port (also known as a Firewire port), a serial port, network adapter 1308, and/or a universal serial bus (USB).

A display device 1311 may also be connected to the bus 1313 via an interface, such as a display adapter 1309. It is contemplated that the computer 1301 may have more than one display adapter 1309 and the computer 1301 may have more than one display device 1311. A display device 1311 may be a monitor, an LCD (Liquid Crystal Display), a light-emitting diode (LED) display, a television, a smart lens, smart glass, and/ or a projector. In addition to the display device 1311, other output peripheral devices may comprise components such as speakers (not shown) and a printer (not shown) which may be connected to the computer 1301 via Input/Output Interface 1310. Any step and/or result of the methods may be output (or caused to be output) in any form to an output device. Such output may be any form of visual representation, including, but not limited to, textual, graphical, animation, audio, tactile, and the like. The display 1311 and computer 1301 may be part of one device, or separate devices.

The computer 1301 may operate in a networked environment using logical connections to one or more remote computing devices 1314A,B,C. A remote computing device 1314A,B,C may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network nodes, and so on. Logical connections between the computer 1301 and a remote computing device 1314A,B,C may be made via a network 1315, such as a local area network (LAN) and/or a general wide area network (WAN). Such network connections may be through a network adapter 1308. A network adapter 1308 may be implemented in both wired and wireless environments. Such networking environments are conventional and commonplace in dwellings, offices, enterprise-wide computer networks, intranets, and the Internet.

Application programs and other executable program components such as the operating system 1305 are shown herein as discrete blocks, although it is recognized that such programs and components may reside at various times in different storage components of the computing device 1301, and are executed by the one or more processors 1303 of the computer 1301. An implementation of audio software 1306 may be stored on or sent across some form of computer-readable media. Any of the disclosed methods may be performed by processor-executable instructions embodied on computer-readable media.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
determining, by a user device, based on a first portion of an audio input, a first direction associated with the first portion of the audio input;
determining, based on a second portion of the audio input, a second direction associated with the second portion of the audio input; and
based on a difference between the first direction and the second direction, causing processing of the audio input without the second portion of the audio input.

2. The method of claim 1, wherein the user device comprises a voice enabled device.

3. The method of claim 1, further comprising:
sending, based on a difference between the first direction and the second direction, an end of speech indication, wherein the end of speech indication is configured to cause one or more of: an exclusion from processing or a termination of one or more audio processing functions.

4. The method of claim 3, further comprising causing, based on the end of speech indication, termination of one or more audio processing functions.

5. The method of claim 1, wherein determining the second direction associated with the second portion of the audio input comprises determining a phase shift.

6. The method of claim 5, wherein the phase shift comprises a phase difference determined between one or more microphones associated with the user device, the method further comprising determining the phase shift satisfies a phase shift threshold.

7. The method of claim 1, wherein causing processing of the audio input without the second portion of the audio input comprises not sending the second portion of the audio input.

8. A method comprising:
receiving, from a user device associated with an audio source, audio data;
processing the audio data;
receiving, from the user device, based on a change in direction associated with the audio source, an end of speech indication; and
based on the end of speech indication, sending a response to a portion of the audio data received before the end of speech indication.

9. The method of claim 8, wherein the user device comprises a voice enabled device.

10. The method of claim 8, wherein the audio data is associated with an audio input comprising a wake word received by the user device and wherein the audio data comprises one or more speech inputs.

11. The method of claim 8, wherein processing the audio data comprises one or more of:
speech recognition, speech to text transcription, determining one or more queries, determining one or more commands, executing one or more queries, or executing one or more commands.

12. The method of claim 8, further comprising determining a phase shift associated with the audio data.

13. The method of claim 8, further comprising sending, to the user device, based on the change in direction of the audio source, a change of direction indication.

14. The method of claim 8, further comprising one or more of: excluding audio data from processing or terminating one or more audio processing operations.

15. A method comprising:
determining, by a user device, based on first phase data associated with a first portion of an audio input and second phase data associated with a second portion of the audio input, a change in a position of an audio source associated with the audio input; and
based on the change in the position of the audio source, sending the first portion of the audio input and an indication that the first portion of the audio input comprises an end of speech.

16. The method of claim 15, wherein the user device comprises a voice enabled device and wherein the first portion of the audio input comprises a wake word received by a user device.

17. The method of claim 15, further comprising processing one or more of the first portion of the audio input or the second portion of the audio input.

18. The method of claim 17, wherein processing one or more of the first portion of the audio input or the second portion of the audio input comprises performing one or more of:
natural language processing, natural language understanding, speech recognition, speech to text transcription, determining one or more queries, determining one or more commands, sending one or more responses, executing one or more queries, sending or receiving data, or executing one or more commands.

19. The method of claim 15, wherein the change in position of the audio source is associated with a phase shift of an audio input.

20. The method of claim 15, further comprising receiving, by the user device, based on the indication that the first portion of the audio input comprises an end of speech, one or more of: a message indicating the second portion of the audio input has been excluded from processing a message indicating one or more processing operations have been terminated.
